(19) United States
(12) Patent Application Publication
(10) Pub. No.: US 2009/0246531 A1
(43) Pub. Date: Oct. 1, 2009

(54) PROCESS FOR THE PRODUCTION OF A STIFFENER THAT IS SCOOPED OUT IN THE SHAPE OF AN OMEGA AND CORE FOR THE PRODUCTION OF A STIFFENER THAT IS SCOOPED OUT IN THE SHAPE OF AN OMEGA

(75) Inventors: Philippe BLOT, Nantes (FR); Gregory LEROUX, Jean Dermozay (FR); Maxime JOUVE, Toulon (FR)

Correspondence Address: YOUNG & THOMPSON, 209 Madison Street, Suite 500, ALEXANDRIA, VA, 22314, US

(73) Assignee: AIRBUS FRANCE, Toulouse (FR)

(21) Appl. No.: 12/413,743

(22) Filed: Mar. 30, 2009

(30) Foreign Application Priority Data
Mar. 28, 2008 (FR) 08 52030

(51) Int. Cl. B32B 9/04; B32B 37/00

(52) U.S. Cl. 428/411.1; 156/293; 156/155

(57) ABSTRACT

A process for obtaining a core for the production of a stiffener (12) on a surface (14) of an element (10) that is to be made rigid, whereby the core is able to be placed between the element (10) to be made rigid and the stiffener (12) so as to obtain a cavity, includes steps of: Producing a central part (20) whose geometry is adapted to that of the cavity, whereby the central part (20) is made of a material that can dissolve or disintegrate; Inserting the central part (20) into an envelope (22) that is made of a thermo-retractable material; and Heating at least the envelope (22) so as to obtain its retraction around the central part (20).

This invention relates to a process for the production of a stiffener that is scooped out in the shape of an omega as well as a core for the implementation of the process.

In the aeronautical field, stiffeners are used in order to enhance mechanical characteristics of certain elements, such as, for example, the panels that form the fuselage.

When the element that is to be made rigid and the stiffener are metal, they are assembled after having been shaped, for example by riveting or bonding.

In order to reduce the onboard weight, the metal elements tend to be replaced by elements that are made of composite material.

According to a technique for assembling elements that are made of composite material, a core is inserted between the element to be made rigid and the stiffener that are not polymerized at the time of installation of the core but during the same cycle.

This core is necessary to keep the elements that are not yet rigid in the desired position until polymerization takes place.

According to a first technique, an extractable core made of silicone, rubber or foam, as described, for example, in the document U.S. Pat. No. 5,547,629, is used.

After polymerization, the core is removed by pulling on one of its ends. The traction of the core causes a contraction of its section that facilitates its removal from the cavity.

This type of core is not completely satisfactory because the core has to be made of a material with a relatively high elongation coefficient to facilitate its removal. This type of material, however, tends to have an expansion coefficient that does not make it possible to obtain the required dimensional details. On the contrary, if a material is selected for the core that makes it possible to obtain the required dimensional details, its service life is limited to several cycles, and it may be difficult to remove it from the cavity of the stiffener because of a low elongation coefficient.

Furthermore, in some cases, these deformable cores cannot be removed, for example in the case of a section variation, of a non-rectilinear core or of a great length. The fact of not being able to remove the core leads to increasing the weight of the part and therefore of the aircraft without any improvement of the mechanical characteristics.

According to a second technique, a core that can be dissolved or disintegrated is used.

According to a first embodiment, the core is made of a water-soluble material.

According to another variant that is described in the document FR-2,576,546, the core is made from a sand agglomerate and a binder that consists of a formo-phenolic resin that is polymerized with a hardening agent such as diisocyanate in the presence of a catalyst such as an amine, preferably liquid. After the production of the part around the core, the latter is disintegrated by means of an organic solvent.

The cores that can be dissolved or disintegrated are not satisfactory because they are relatively fragile and can break during handling. Furthermore, they do not make it possible to ensure a good surface condition to be able to perform non-destructive testing. Finally, these cores are not sealed against the resin, although the destruction of the core can no longer be possible after the polymerization.

Also, this invention aims at eliminating the drawbacks of the prior art by proposing a process for obtaining a core for the production of a scooped-out stiffener, simple to use and making it possible to ensure the required dimensional details.

For this purpose, the invention has as its object a process for obtaining a core for the production of a stiffener on a surface of an element that is to be made rigid, whereby said core can be placed between the element that is to be made rigid and the stiffener so as to obtain a cavity, characterized in that it consists in:
Producing a central part whose geometry is adapted to that of the cavity, whereby said central part is made of a material that can dissolve or disintegrate,
Inserting said central part into an envelope that is made of a thermo-retractable material, and
Heating at least said envelope so as to obtain its retraction around said central part.

Other characteristics and advantages will emerge from the following description of the invention, a description that is provided only by way of example, opposite the accompanying drawings in which:

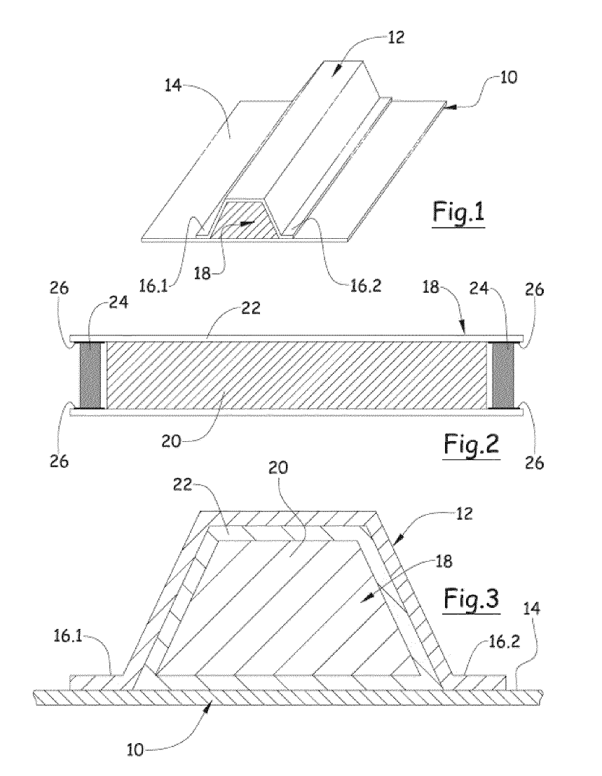

FIG. 1 is a perspective view of a stiffener that is installed on an element that is to be made rigid,

FIG. 2 is a longitudinal cutaway view that illustrates the various parts of a core according to the invention, and

FIG. 3 is a transversal cutaway view that illustrates the various parts of a core according to the invention.

In the figures, an element that is to be made rigid, hereinafter “panel,” and able to form a part of the fuselage of an aircraft, for example, is shown at 10, and a stiffener that is added to one of the surfaces 14 of said panel 10 is shown at 12. At least one of the two elements 10, 12 is made of composite material.

For the rest of the description, the longitudinal direction corresponds to the direction of the largest dimension of the stiffener that is parallel to the panel, whereby the transverse direction is the direction that is perpendicular to the longitudinal direction and parallel to the panel.

In a transverse direction, the stiffener 12 comprises two zones 16.1 and 16.2 for contact with the surface 14 between which the stiffener 12 and the panel form a cavity. This cavity emerges into at least one of the ends of the stiffener 12 and preferably into two ends.

According to an embodiment, the stiffener has an Omega profile along a transverse cutaway, namely in the shape of a U that is upside-down and tapered with a flange on both sides that forms the contact zones with the surface 14, as illustrated in FIG. 1.

As appropriate, the panel 10 can have a flat or curved profile.

Thus, the panel 10 can be hollow (in an undercut) at the surface 14, for example arising from a release of folds, namely a reduction in the number of folds forming the panel at certain zones of the panel.

As appropriate, the panel 10 and/or the stiffener 12 can have undercut shapes.

According to a first solution, the stiffener 12 is installed on the panel 10, and the two elements 10 and 12 are polymerized during the same cycle.

According to another solution, the stiffener 12 is installed on the panel 10 whereas one of the two elements is already at least partially polymerized.

In all cases, before the stiffening of the last element 10 or 12 by polymerization, a core 18 is inserted between the stiffener 12 and the panel 10 in the cavity so as to ensure the geometry of the stiffener after polymerization.

According to the invention, the core 18 comprises a central part 20, hereinafter “heart,” that is made of a material that can dissolve or disintegrate, and a flexible and sealed envelope 22 that surrounds and isolates said stiffener heart and panel, as illustrated in FIGS. 2 and 3.

The heart 20 is preferably made of a water-soluble material. By way of example, the heart 20 is made of a material that is marketed under the trade name Aquacore 1024.

In a first step, the material of the heart 20 should allow it to be in the solid state and to have a certain geometry, and in a second step to be in the liquid/pasty state or in the form of powders or separate elements to be able to be extracted from the envelope and the cavity that is formed by the stiffener and the panel. According to a characteristic of the invention, the flexible and sealed envelope 22 is made of a thermo-retractable material. The fact that the envelope 22 is made of a retractable material simplifies the implementation of the process.

The envelope 22 is made by using a thermo-retractable polymer material that is compatible with the resin of the composite material, in particular its chemical nature and its polymerization temperature.

To obtain a core, the heart 20 is placed in the envelope 22, and then the latter undergoes an increase in temperature so as to obtain its retraction.

Thus, the retraction of the envelope 22 after heating exerts a shrinking-on on the heart 20 that imparts to it better mechanical characteristics, in particular on matters of rigidity, resistance and cohesion, and thus limits the risks of damage during handling.

Preferably, the envelope 22 is made of a material that imparts a smooth surface condition to said envelope at its outside surface (in contact with the stiffener or the panel), in particular after retraction. Thus, at the surfaces of the stiffener and the panel in contact with the core, a smooth surface condition is obtained that allows the non-destructive testing of the composite material, for example by reflection.

To be able to extract the flexible envelope 22 after polymerization and removal of the heart 20, said envelope 22 is made of a non-adhesive material, for example polytetrafluoroethylene or vinylidine polyfluoride, or it is coated by a demolding agent prior to the installation of the core.

Thus, the selection of material for forming the envelope is guided by the following criteria:
Surface condition after contraction,
Contraction temperature,
Contraction coefficient, and
Adhesion of the envelope.

Advantageously, the envelope 22 is made of polytetrafluoroethylene or vinylidene polyfluoride whose characteristics are provided in the following table:

| | Characteristics of the Envelope | |
|---|---|---|
| Trade Name | TEFLON ® (PTFE4) | KINAR ® |
| Composition | Polytetrafluoroethylene | Vinylidene |
| | | Polyfluoride |
| Contraction Temperature in ° C. | 330 | 180 |
| Surface Condition after | Poor | Very Good |
| Contraction | | |
| Contraction Coefficient | 4:1 | 2:1 |
| Adhesion | Low | Average |
| (in particular with Resin) | | |

Preferably, the envelope is made of KINAR®, taking into account the surface condition obtained and the lower contraction temperature.

According to one embodiment, the envelope 22 comprises at least one opening to make possible the insertion and extraction of the heart 20, whereby said opening is blocked at least during polymerization.

Preferably, the envelope 22 comes in the form of a sheath that is open at each of its ends, into which the heart 20 can be introduced in the solid state.

After the heart is introduced, the ends of the sheath 22 are closed in a sealed manner.

According to a first variant embodiment, the ends can be welded. Thus, the two parts of the sheath 22 that extend beyond the two sides of the heart are heated until the material becomes viscous, and then are welded by using a heating clamp.

According to another variant embodiment illustrated in FIG. 2, two plugs 24 are used to block the ends of the sheath 22. These plugs can be connected to the sheath by being shrunk on during the retraction of the sheath 22. According to another advantage, the solid plug that is flattened against the heart makes it possible to limit the contraction during the retraction of the sheath at each end. A putty 26 can be inserted between the solid plugs and the sheath to reinforce the seal.

By way of example, the core is made in the following manner.

In a first step, a heart 20 is made, for example by molding.

Next, said sheath that has excess length on both sides of the heart 20 is inserted into the sheath 22 via one of its ends. To have as high-performing a contraction as possible, it is necessary to provide a circumference of the envelope along a transverse section that is 10 to 20% larger than that of the core. The two plugs 24 are then put into contact with the heart 20 at each of the ends of the sheath 22. The sheath 22 is then heated to obtain its retraction. The contraction will make it possible to obtain a shrinking-on of the envelope on the heart and on the plugs so as to obtain a sealed and rigid core in a single step. Optionally, the seal at each end can be reinforced by using a putty 26.

The invention makes it possible to obtain a non-rectilinear core 18 that can have sections of variable dimensions that are optionally adapted to undercut shapes of the stiffener and/or panel. According to the invention, only the heart 20 has shapes that are adapted to that of the cavity. The sheath 22 can have a rectilinear section and automatically adapts to the shape of the heart during the retraction.

The thus produced core 18 is used in the following manner:

The core 18 is installed on the panel. The stiffener is added to the core 18, as illustrated in FIG. 1.

After polymerization, the envelope 22 is opened, in particular by removing one of the plugs 24. The heart 20 is then at least partially dissolved. The thus dissolved elements are taken out of the envelope via the opening. After the removal of at least a portion of these elements, the envelope 22 is removed.

According to the invention, a scooped-out stiffener is thus obtained.

The core according to the invention makes it possible to obtain the geometric precision that is required using the shape of the heart 20.

It later makes it possible to test the thus produced part using the good surface condition of the inside of the cavity that emerges from the use of the retractable envelope 22.

Whereas the retractable envelope is perfectly sealed against the resin, the destruction of the core after polymerization of the resin is still possible.

The retraction of the envelope also makes it possible to greatly improve the mechanical characteristics of the core, thus limiting the risks of damage during handling.

The core can be used during the implementation of a stiffener and a panel that are not completely polymerized (crude), polymerized during the same cycle in the presence of the core, or with at least one of these two elements that are polymerized prior to the installation of the core.

According to another application, the core can be used for the installation of textile preforms that form stiffeners and a textile preform that forms a panel and for ensuring the internal geometry of the stiffeners during the injection and the polymerization of the resin.

The core can be used for non-plane panels and makes it possible to obtain stiffeners of great lengths.

Finally, the use of the core is relatively simple and does not require complex equipment.

1. Process for obtaining a core for the production of a stiffener (12) on a surface (14) of an element (10) that is to be made rigid, whereby said core is able to be placed between the element (10) to be made rigid and the stiffener (12) so as to obtain a cavity, characterized in that it consists in:
Producing a central part (20) whose geometry is adapted to that of the cavity, whereby said central part (20) is made of a material that can dissolve or disintegrate,
Inserting said central part (20) into an envelope (22) that is made of a thermo-retractable material, and
Heating at least said envelope (22) so as to obtain its retraction around said central part (20).

2. Process for obtaining a core according to claim 1, wherein it consists in using a sheath (22) with at least one opening through which the central part (20) is inserted and in blocking each opening by a plug (24) before heating said sheath (22) in order to obtain its retraction around said central part and plug(s) (24).

3. Process for obtaining a core according to claim 1, wherein the central part (20) is made of a water-soluble material.

4. Process for obtaining a core according to claim 1, wherein the flexible and sealed envelope (22) is made of polytetrafluoroethylene.

5. Process for obtaining a core according to claim 1, wherein the flexible and sealed envelope (22) is made of vinylidene polyfluoride.

6. Process for obtaining a core according to claim 2, wherein a sheath (22) is used which, before retracting, has a circumference that is 10 to 20% greater than the circumference of the central part (20).

7. Core that is obtained from the process according to claim 1.

8. Process for the production of a stiffener (12) that is scooped out on the surface of an element (10) that is to be made rigid, whereby at least one of the two is made of a composite material that is not completely polymerized, whereby said stiffener is emerging at least at one of its ends, and whereby said process consists in placing a core (18) between said stiffener (12) and said element (10) that is to be made rigid, wherein it consists in:
Using a core that comprises a central part (20) that is made of a material that can dissolve or disintegrate and a thermo-retracted envelope (22) around said central part (20) of said element (10) that is to be made rigid and of the stiffener (12),
Polymerizing said stiffener (12) and/or said element (10) that is to be made rigid,
Dissolving or disintegrating the central part (20) at least partially,
Removing the elements that are obtained from the dissolution or disintegration of the central part (20) at least partially from the envelope (22), and
Removing the flexible and sealed envelope (22).

9. Process for obtaining a core according to claim 2, wherein the central part (20) is made of a water-soluble material.

10. Process for obtaining a core according to claim 2, wherein the flexible and sealed envelope (22) is made of polytetrafluoroethylene.

11. Process for obtaining a core according to claim 3, wherein the flexible and sealed envelope (22) is made of polytetrafluoroethylene.

12. Process for obtaining a core according to claim 2, wherein the flexible and sealed envelope (22) is made of vinylidene polyfluoride.

13. Process for obtaining a core according to claim 3, wherein the flexible and sealed envelope (22) is made of vinylidene polyfluoride.

14. Process for obtaining a core according to claim 3, wherein a sheath (22) is used which, before retracting, has a circumference that is 10 to 20% greater than the circumference of the central part (20).

15. Process for obtaining a core according to claim 4, wherein a sheath (22) is used which, before retracting, has a circumference that is 10 to 20% greater than the circumference of the central part (20).

16. Process for obtaining a core according to claim 5, wherein a sheath (22) is used which, before retracting, has a circumference that is 10 to 20% greater than the circumference of the central part (20).

17. Core that is obtained from the process according to claim 2.

18. Core that is obtained from the process according to claim 3.

19. Core that is obtained from the process according to claim 4.

20. Core that is obtained from the process according to claim 5.
